(19) United States
(12) Patent Application Publication
(10) Pub. No.: US 2014/0225912 A1
(43) Pub. Date: Aug. 14, 2014

(54) REDUCED METAMERISM SPECTRAL COLOR PROCESSING FOR MULTI-PRIMARY DISPLAY DEVICES

(71) Applicant: QUALCOMM MEMS TECHNOLOGIES, INC., San Diego, CA (US)

(72) Inventors: Alok Govil, Fremont, CA (US); Pouya Bastani, Vancouver (CA); Behnam Bastani, San Jose, CA (US)

(73) Assignee: QUALCOMM MEMS TECHNOLOGIES, INC., San Diego, CA (US)

(21) Appl. No.: 13/764,347

(22) Filed: Feb. 11, 2013

(51) Int. Cl. G09G 5/02

(52) U.S. Cl. CPC G09G 5/02
USPC 345/593

(57) ABSTRACT

This disclosure provides systems, methods and apparatus, including computer programs encoded on computer storage media, for spectral color processing for multi-primary display devices. In one aspect, the display device can include display elements and a processor. The processor can create an output color palette of colors and transform the output color palette to a spectral space color palette. The processor also can receive data on an input color to be output by the display device, separate the input color into a combination of the primary colors that can create the input color, and transform the input color to the spectral space. Furthermore, the processor can select a color in the spectral space color palette based at least in part on the input color in the spectral space. The selected color can reduce metamerism.

### TECHNICAL FIELD

This disclosure relates to reducing metamerism with multi-primary display devices, including multi-primary display devices utilizing electromechanical systems.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

For example, display devices configured to display an image can include IMOD display elements to produce the different colors of the image. In some such devices, red, green, and blue IMOD display elements can reflect three primary colors of light, e.g., red, green, and blue light respectively. Some display devices, e.g., multi-primary display devices, can utilize more than three primary colors.

### SUMMARY

The systems, methods and devices of this disclosure each have several innovative aspects, no single one of which is solely responsible for the desirable attributes disclosed herein.

One innovative aspect of the subject matter described in this disclosure can be implemented in a multi-primary display device configured to output a number of primary colors that is greater than or equal to four. The display device can include display elements and a processor in communication with the display elements. Each display element can be configured to output at least one of the primary colors. The processor can be configured to create an output color palette of colors capable of being output by the display elements of the multi-primary display device. The processor also can be configured to transform the output color palette to a spectral space color palette. The spectral space can have a dimensionality based at least in part on a wavelength range associated with the primary colors. The processor further can be configured to receive data on an input color to be output by the multi-primary display device, separate the input color into a combination of the primary colors that can create the input color, and transform the input color to the spectral space. Furthermore, the processor can be configured to select a color in the spectral space color palette based at least in part on the input color in the spectral space. The selected color can reduce metamerism.

In some implementations of the display device, the spectral space can have a dimensionality based at least in part on a sampling interval of the wavelength range. Also, in certain implementations, the display elements can be temporally modulated such that the display elements can be capable of outputting one or more of the primary colors for respective amounts of time in a number of time slots. The processor in some implementations, can be configured to separate the input color by using a subvolume method to determine the primary colors for creating the input color. The processor also can be configured to transform the input color to the spectral space based at least in part on the separated input color and spectra of the primary colors. Furthermore, the processor can be configured to select the color as the color in the spectral space color palette that is closest to the input color. In some examples, the processor can be configured to select the closest color using an L₂-norm in the spectral space. Also, the processor can be configured to select the color in a reduced-dimensionality spectral space having fewer dimensions than the dimensionality of the spectral space. For example, the reduced-dimensionality spectral space can be determined using principle component analysis.

In some implementations of the display device, the processor can be further configured to (1) for a first set of display elements, determine, in the spectral space, a quantization error between the selected color and the input color, and (2) diffuse, in the spectral space, the quantization error to a second set of display elements neighboring the first plurality of display elements. The processor can be configured to diffuse the quantization error to the neighboring set of display elements using a dithering algorithm. The processor can be further configured to communicate the selected color to at least one display element to produce the input color on the multi-primary display device.

In some implementations, the display device can include a display and a memory device. For example, the processor can be configured to process image data and communicate with the display. The memory device can be configured to communicate with the processor. The image data can include the data on the input color. The display device can further include a driver circuit and a controller. The driver circuit can be configured to send at least one signal to the display. The controller can be configured to send at least a portion of the image data to the driver circuit. The display device further can include an image source module configured to send the image data to the processor. The image source module can include at least one of a receiver, transceiver, and transmitter. The display device also can include an input device configured to receive input data and to communicate the input data to the processor. Each display element can include an interferometric modulator.

Another innovative aspect of the subject matter described in this disclosure can be implemented in a multi-primary display device configured to output a number of primary colors that is greater than or equal to four. The display device can include means for displaying at least one of the primary colors. The display device also can include means for processing in communication with the displaying means. The processing means can be configured to create an output color palette of colors capable of being output by the displaying means of the multi-primary display device. The processing means also can be configured to transform the output color palette to a spectral space color palette. The spectral space can have a dimensionality based at least in part on a wavelength range associated with the primary colors. The processing means also can receive data on an input color to be output by the multi-primary display device, separate the input color into a combination of the primary colors that can create the input color, and transform the input color to the spectral space. In addition, the processing means can select a color in the spectral space color palette based at least in part on the input color in the spectral space. The selected color can reduce metamerism.

In certain implementations of the display device, the spectral space can have a dimensionality based at least in part on a sampling interval of the wavelength range. The displaying means can include display elements or the processing means can include a processor. Each display element can include an interferometric modulator. The displaying means can be temporally modulated such that the displaying means is capable of outputting one or more of the primary colors for respective amounts of time in a number of time slots. In addition, the processing means can be configured to transform the input color to the spectral space based at least in part on the separated input color and spectra of the primary colors. The processing means also can be configured to select the color as the color in the spectral space color palette that is closest to the input color. For example, the processing means can be configured to select the closest color using an L₂-norm in the spectral space. Furthermore, the processing means can be configured to communicate the selected color to the displaying means to produce the input color on the multi-primary display device.

Another innovative aspect of the subject matter described in this disclosure can be implemented in a method of processing color on a multi-primary display device. The multi-primary display device can be configured to output a number of primary colors that is greater than or equal to four. The multi-primary display device can include display elements. Each display element can be configured to output at least one of the primary colors. The method can include creating an output color palette of colors capable of being output by the display elements of the multi-primary display device. The method also can include transforming the output color palette to a spectral space color palette. The spectral space can have a dimensionality based at least in part on a wavelength range associated with the primary colors. In addition, the method can include receiving data on an input color to be output by the multi-primary display device, separating the input color into a combination of the primary colors that can create the input color, and transforming the input color to the spectral space. The method further can include selecting a color in the spectral space color palette based at least in part on the input color in the spectral space. The selected color can reduce metamerism. The method can be performed in its entirety by a physical computing device.

In certain implementations, the spectral space can have a dimensionality based at least in part on a sampling interval of the wavelength range. In some implementations of the method, transforming the input color to the spectral space can be based at least in part on the separated input color and spectra of the primary colors. Also, selecting the color can include selecting the color in the spectral space color palette that is closest to the input color. For example, selecting the closest color can include using an L₂-norm in the spectral space. The method can further include communicating the selected color to at least one display element to produce the input color on the multi-primary display device.

Another innovative aspect of the subject matter described in this disclosure can be implemented in a non-transitory tangible computer storage medium. The storage medium can have stored thereon instructions to process color on a multi-primary display device. The multi-primary display device can be configured to output a number of primary colors that is greater than or equal to four. The multi-primary display device can include display elements. Each display element can be configured to output at least one of the primary colors. The instructions when executed by a computing system can cause the computing system to perform operations. The operations can include creating an output color palette of colors capable of being output by the display elements of the multi-primary display device. The operations also can include transforming the output color palette to a spectral space color palette. The spectral space can have a dimensionality based at least in part on a wavelength range associated with the primary colors. In addition, the operations can include receiving from a computer-readable medium data on an input color to be output by the multi-primary display device, separating the input color into a combination of the primary colors that can create the input color, and transforming the input color to the spectral space. The operations further can include selecting a color in the spectral space color palette based at least in part on the input color in the spectral space. The selected color can reduce metamerism.

In certain implementations, the spectral space can have a dimensionality based at least in part on a sampling interval of the wavelength range. In some implementations of the computer storage medium, transforming the input color to the spectral space can be based at least in part on the separated input color and spectra of the primary colors. In addition, selecting the color can include selecting the color as the color in the spectral space color palette that is closest to the input color. For example, selecting the closest color can include using an L₂-norm in the spectral space. The operations can further include communicating the selected color to at least one display element to produce the input color.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5 is an example chromaticity diagram that illustrates the colors that can be produced by a display device using red, green, and blue primary colors in two-dimensional CIEU′V′ space.

FIG. 6 illustrates an example display device configured to select a color that reduces metamerism.

FIG. 7 illustrates an example method of processing color on a display device that selects a color that reduces metamerism.

FIGS. 8A and 8B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Some display devices can produce an input color by utilizing more than three primary colors with reflectance or transmittance characteristics independent of each other. These devices are commonly referred to as multi-primary display devices. There are some advantages when using more than three primary colors. For example, when compared to a display device using only three primary colors, a display device using one or more additional primary color can increase the color gamut of the display device (e.g., a display device including within each pixel an additional IMOD display element reflecting yellow light or a display device including within each pixel an additional IMOD display element reflecting cyan light). However, for such display devices, color processing can become more complicated than for display devices using only three primary colors. For example, in a display device with only Red (R), Green (G), and Blue (B) primary colors per pixel, there is one combination to produce the color having the input RGB values. In contrast, in a display device with more than three primary colors per pixel, there may be more than one combination of primary colors (e.g., metamers) to produce the color having the input RGB values under a given illumination. Metamerism can occur when colors that appear the same under one lighting condition look different under another lighting condition. Additionally, for multi-primary display devices under a given lighting illumination, the metamers can look different upon changes in viewing angle.

Current color processing methods for display devices with more than three primary colors include performing color processing in a trichromatic color space, such as sRGB, International Commission on Illumination (CIE) XYZ, or CIE L*a*b*. In such a relatively low dimensional space, e.g., a three-dimensional space or less than three-dimensional space, colors are created using a much smaller set of discrete colors that can be formed by a combination of primary colors (e.g., a smaller color palette) than is available on the multi-primary display device. Because colors that may appear similar in a trichromatic color space may actually have very different spectra due to a combination of a different set of primary colors, metamerism can occur. Metamerism can be problematic in color rendering on displays using more than three primary colors, as two colors that were initially metameric to each other may become visually distinct under a change of viewing angle. Additionally, nearby colors in an image produced using trichromatic color processing on a multi-primary display device may shift in different amounts under changes in viewing angle, resulting in many dither spots.

As described herein, certain implementations can provide examples of reduced metamerism spectral color processing as well as devices that utilize such a method for multi-primary display devices. In some implementations, a hardware processor can be configured to implement a method that creates an output color palette of colors and transforms the output color palette to a spectral space color palette. The processor also can receive data on an input color to be output by the display device, separate the input color into a combination of the primary colors that can create the input color, and transform the input color to the spectral space. Furthermore, the processor can select a color in the spectral space color palette based at least in part on the input color in the spectral space. The selected color can reduce metamerism. In some implementations, the processor can select the color as the color in the spectral space color palette that is closest to the input color. The processor can also select the color in a reduced-dimensionality spectral space having fewer dimensions than the dimensionality of the spectral space, but more dimensions than the dimensionality of a trichromatic color space. In some implementations, a quantization error between the selected color and the input color can also be diffused in the spectral space to neighboring pixels.

Particular implementations of the subject matter described in this disclosure can be implemented to realize one or more of the following potential advantages. In certain implementations, the selected color can reduce metamerism because the color can be selected from a larger color palette when using a higher dimensional color space (e.g., more than a three-dimensional space) when compared to using a trichromatic color space. When working in the spectral space, colors can be selected by comparing spectra as opposed to only the combined overall color. If two colors have substantially the same spectra or have spectra that change relatively smoothly, color consistency under different viewing conditions can be preserved. Therefore, by performing color processing in the higher dimensional spectral color space, metamerism can be reduced or avoided. In some implementations, all combinations of primaries can be used to form a larger color palette, which generally results in smaller quantization error, and therefore less dither visibility. Accordingly, by performing color processing in the spectral domain, dither visibility can be reduced without introducing (or substantially reducing the effects of) metamerism. Quantization error during halftoning can also be diffused in spectral space to neighboring pixels resulting in less dither spots. This can extend trichromatic error diffusion approaches, where the difference between the desired color and the available color can be diffused to neighboring pixels.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

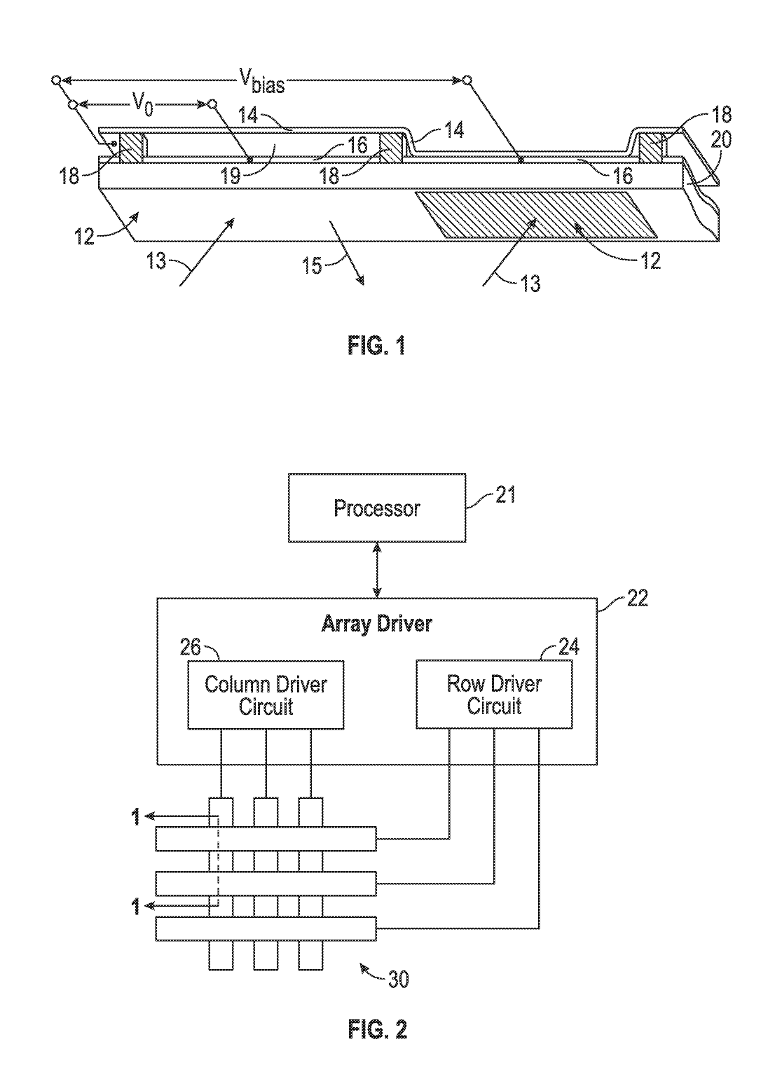

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

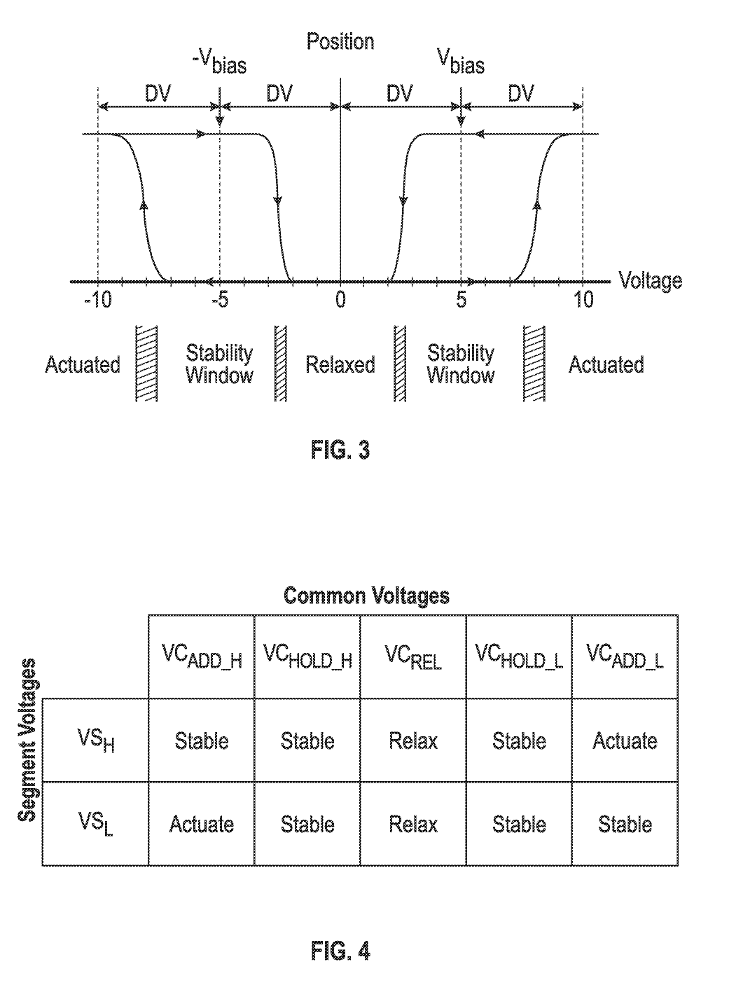

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

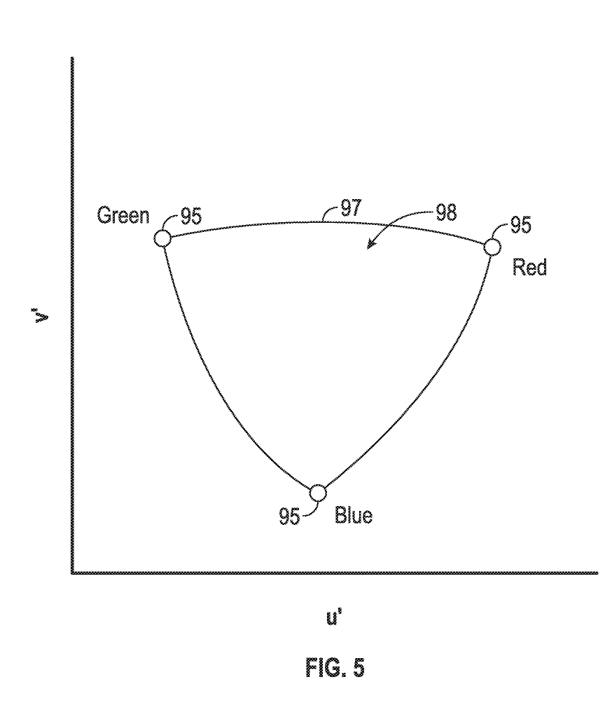

FIG. 5 is an example chromaticity diagram that illustrates the colors that can be produced by an display device using red, green, and blue primary colors in two-dimensional CIEU′V′ space. For example, the display device can include display elements that produce red, green, and blue colors. Display element as used herein can include any element in a display device that is capable of producing at least one primary color, e.g., red, green, blue, cyan, yellow, magenta, white, or black. The display element may also produce a non-traditional primary color (that when combined with one or more other non-traditional primary color produces a color that appear substantially neutral, e.g., gray, white or black) such as purplish-blue and greenish-yellow. The display element may also produce one or more other primary colors, e.g., orange or violet. The term “primary color” or “primary”, as used herein, can refer to a color within the set of colors in an display device that can be combined (e.g., additively) to produce the range of colors (or color gamut) of the display device. For example, the primary colors in certain implementations of a display device can be the set of colors produced by the subpixels of a pixel.

As shown in FIG. 5, the chromaticity coordinates of a particular color can be defined by the horizontal and vertical axes (u′,v′) of the chromaticity diagram. The u′,v′ values are designed to measure the chromaticity of a color. These coordinates can be represented by various color space models, e.g., (u′,v′) in CIE L*u′v′, (a*,b*) in CIE L*a*b* color space, (X,Z) in CIE XYZ color space, or (x,y) in CIE xyY color space, where the two-dimensional coordinates, e.g., (x,y), can represent the chromaticity of a color and the third dimension, e.g., (Y), can measure the brightness (or luminance or intensity) of the color. The chromaticity coordinates of a particular color can also be defined using other color space models which may not separate out the chromaticity, e.g., three-dimensional coordinates in an RGB color model, standard RGB color model (e.g., sRGB), or LMS coordinates in a von Kries color model that can utilize Long, Medium, and Short wavelength values.

In FIG. 5, the end points 95 of the trace 97 can define the color produced by red, green, and blue primary colors in two-dimensional space. At least a portion of the trace 97 can be concave, convex, or straight. The region 98 enclosed within the trace 97 can correspond to the range of colors that can be generated by mixing the colors produced at end points 95. This range of colors can be referred to as the color gamut of the display device. In operation, each of the red, green and blue display elements, e.g., subpixels in a pixel of a display, can be controlled to produce different mixtures of the red, green, and blue colors that combine to form each color within the color gamut. Thus, to produce a color having an input color chromaticity value within the red, green, blue color gamut, there is one combination in a display device with only red, green, and blue primary colors. In other words, for a display device with only three primary colors, there is generally only one combination of the primary colors to produce the input color.

The color gamut of the display device may be defined by more than three primary colors. For example, the display device may include red, green, blue, and white primary colors (RBGW), cyan, yellow, magenta, and black primary colors (CYMK), red, green, blue, cyan, yellow, and magenta primary colors (RGBCYM), or some other combination of traditional and/or non-traditional primary colors (e.g., RGBY, RGBC, RBGYC, RGBWK, ROYGCBWK, etc.). In a display device with more than three primary colors, e.g., a multi-primary display device, there may be more than one combination of primary colors that produces the color having the input color chromaticity value. The number of primary colors used in the display device can be four, five, six, seven, eight, or more, in various implementations.

When multiple primary combinations are available to create an input color and color processing is performed in a three-dimensional space, due to the relatively low dimensionality of the working space, a common method to avoid metamerism is to reduce the choices of color combinations. This results in the reduction of available colors or the color palette (e.g., the set of discrete colors that can be formed via combination of primaries). By processing colors in a higher dimensional space, such as the spectral domain having at least four-dimensions, it is possible with certain implementations as described herein to use a larger color palette and at the same time substantially avoid metamerism.

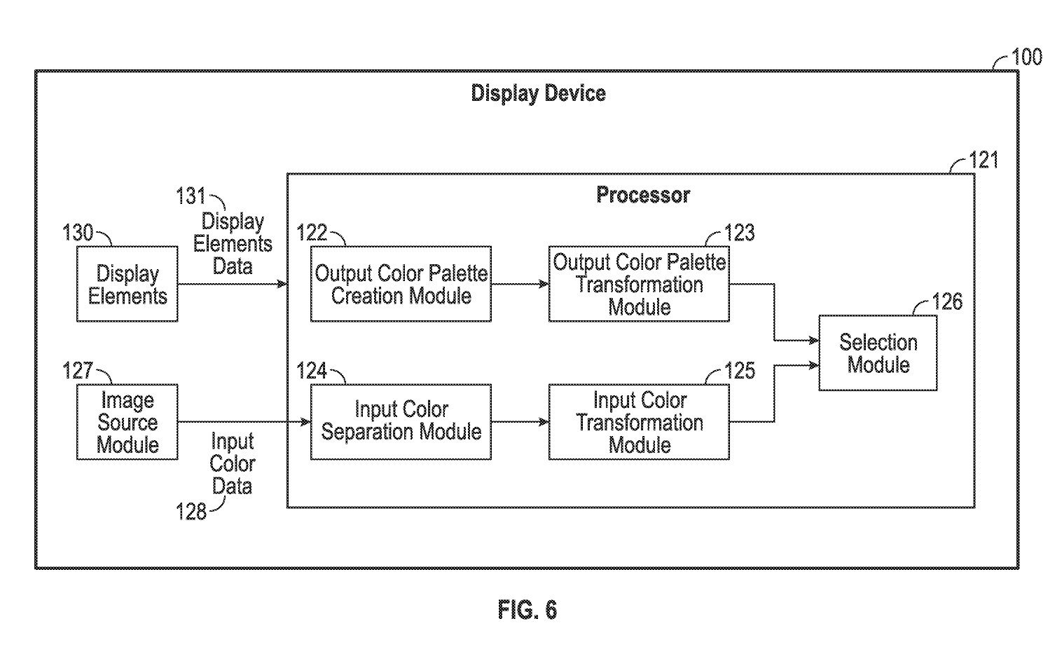

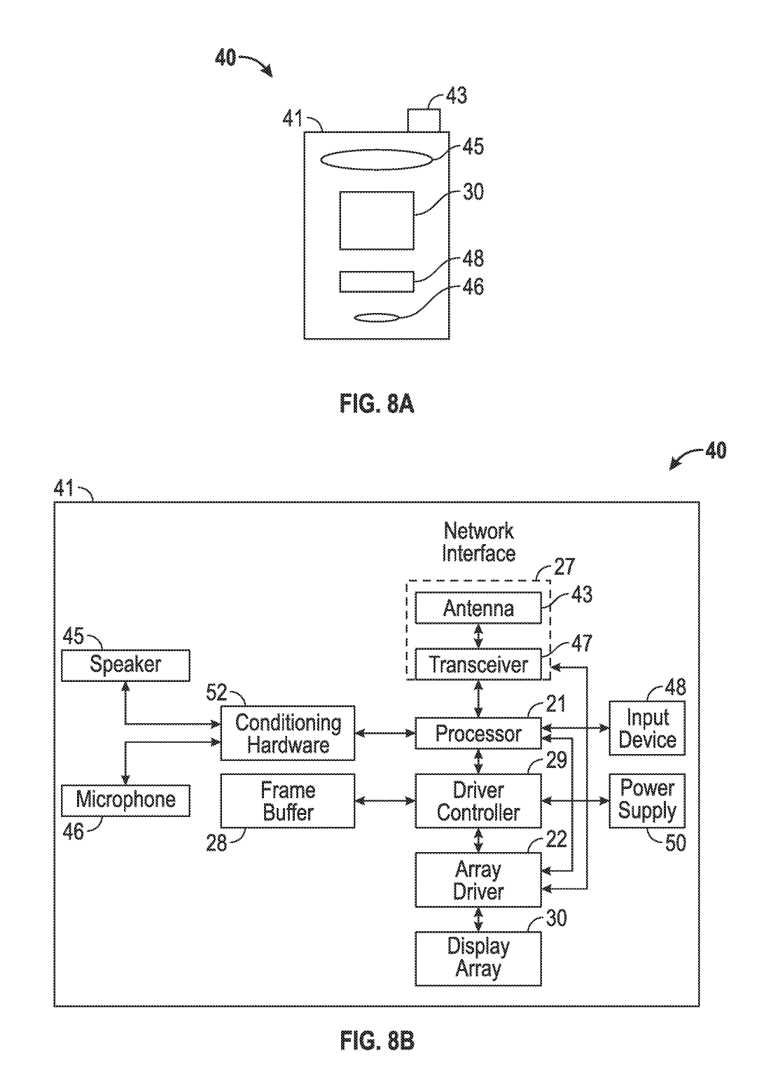

FIG. 6 illustrates an example display device configured to select a color that reduces metamerism. The display device 100 can be any display device configured to output a number of primary colors, e.g., to display an image. For example, the display device 100 can be a display (reflective, transmissive, or transflective), or any other display device, for example, display device 40 as shown in FIGS. 8A and 8B or any of those listed herein. In some implementations of the display device 100, the number of primary colors is equal to two (e.g., black and white). In other implementations, the number of primary colors is equal to three (e.g., red, green, and blue). In yet other implementations (e.g., in a multi-primary display device), the number of primary colors is greater than or equal to four (e.g., four, five, six, seven, eight, or more). The primary colors may be selected to cover a wavelength range for visible wavelengths, which in some cases can be between about 370 nm to about 730 nm.

The display device 100 can include a set of display elements 130 and a hardware processor 121. Each of the display elements 130 can be configured to output at least one of the primary colors. As will be described herein, the processor 121 can be configured to select a color that reduces metamerism. For example, the processor 121 can create an output color palette of colors capable of being output by the display elements 130 of the display device 100, and can transform the output color palette to a spectral space color palette. The processor 121 also can receive data on an input color to be output by the display device 100, separate the input color into a combination of the primary colors that can create the input color, and transform the input color to the spectral space. Furthermore, the processor 121 can select a color in the spectral space color palette based at least in part on the input color in the spectral space. The selected color can reduce metamerism.

Display elements 130 as used herein can include elements in a display device that can be capable of producing at least one primary color, e.g., red, green, blue, cyan, yellow, magenta, white, black, or any non-traditional primary color. Thus, in some implementations, the primary color can be associated with a non-white primary color. In other implementations, the primary color can be associated with a white primary color. The primary colors of the display elements 130 can form a color gamut of the display device 100. Thus, in some implementations, each of the display elements 130 can include a subpixel of a pixel of the display device 100.

At least one of the display elements 130 can include one or more IMOD display elements as described herein. In some implementations, an IMOD display element operating in a bi-stable mode (e.g., an interferometric modulator having a fixed cavity height) can be used. In some other implementations, an IMOD display element operating in a multi-state mode (e.g., an interferometric modulator having fixed cavity heights for each state of operation) can be used. In yet other implementations, an IMOD display element operating in an analog mode (e.g., an interferometric modulator having a variable cavity height) can be used. Whether bi-stable, multi-state, or analog, each IMOD display elements can have an interferometric cavity and can be configured to modulate ambient light. IMOD display elements can be configured to operate in transmissive or reflective devices. For example, as discussed herein, the spacing of the interferometric cavity can affect the reflectance of the IMOD display element which, in turn, can generate different colors.

Thus, in some implementations, the display elements 130 can be modulated such that the display elements 130 are capable of outputting one or more of the primary colors by varying one or more of the spacings of the interferometric cavities. Additionally or alternatively, the display elements 130 can be modulated such that the display elements 130 are capable of outputting one or more of the primary colors by varying one or more of the reflective (or transmissive) areas. Furthermore, in some implementations, the display elements 130 can be temporally modulated such that the display elements 130 are capable of outputting one or more of the primary colors for respective amounts of time in a number of time slots. The display elements 130 can also include other types of display elements, including one or more liquid crystal or source of colored light. For example, the display device 100 can be a liquid crystal display (LCD) or a light emitting diode (LED) display.

The display device 100 further can include a processor 121 in communication with the display elements 130. In some implementations, the processor 121 can be the processor 21 of FIG. 2 or FIG. 8B. The processor 121 can include a microcontroller, a central processing unit (CPU), or logic unit to control operation of the display device 100. The processor 121 can be configured to perform color processing that reduces metamerism in a multi-primary display device.

In some possible approaches of color processing for a multi-primary display device (e.g., a separate volume or a subvolume method), the color gamut can be divided into separate volumes (e.g., tetrahedra). For instance, with eight primary colors, the color gamut can be divided into six separate tetrahedra. The primary colors at four corners of the tetrahedra can be used to create the input color. In some approaches, temporal modulation can be used such that different primary colors are output in different time slots (or temporal planes). The color palette formed by temporal modulation of primary colors can be restricted to the set of colors formed within each tetrahedron combined with the other colors formed within other tetrahedra. For instance, with four temporal planes and eight primary colors, there can be 384 non-identical colors created with the six separate tetrahedra. In this way, metamerism may possibly be avoided when performing color processing in a trichromatic color space, e.g., sRGB. This, however, is a much smaller set of colors that can be rendered on the multi-primary display device. For example, with four temporal planes and eight primary colors, there can be 17920 possible colors created with 70 overlapping tetrahedra. By performing color processing in the spectral domain compared to a trichromatic color space, certain implementations described herein can take advantage of the relatively higher dimensionality of the space to use a larger color palette, e.g., a full color palette in some instances, and at the same time substantially avoid metamerism.

One example display device 100 that can perform color processing in the spectral domain is shown in FIG. 6. In some implementations, the processor 121 can include one or more modules to perform the color processing, such as the modules 122-126. The processor 121, e.g., by an output color palette creation module 122, can create an output color palette of colors capable of being output by the display elements 130 of the display device 100. The processor 121 can receive display elements data 131. In some implementations, the display elements data 131 can include identification and/or a number N of the primary colors associated with the display elements 130. If temporal modulation is used, the display elements data 131 can also include the number t of time slots (or temporal planes) used for temporal modulation. In some examples, a given time slot can be split in different formats between the available colors. Thus, the display elements data 131 can also include the number of time slots and/or the formats used for the available colors. In such an example, the processor 121 can form all possible assignments of the primary colors to time slots. For example, the output color palette creation module 122 can create the output color palette of colors capable of being output by the display elements 130 that can be represented by a matrix B of the coefficients of linear combination of the N primary colors possible using the available t time slots. As one example using five primary colors (e.g., red, green, blue, cyan, and magenta) and four time slots of relative durations [a,b,c,d], where a+b+c+d=1 (1 can represent the length of a whole frame), one linear combination can be [0, b, a, c+d, 0], representing a color that can be formed by outputting red for a relative amount of time equal to 0, green for a relative amount of time equal to b, blue for a relative amount of time equal to a, cyan for a relative amount of time equal to (c+d), and magenta for a relative amount of time equal to 0. Another possible linear combination can be [c, a+c+d, 0, 0, b]. The matrix B has matrix dimensions of N×m, where m is the number of possible primary linear combination coefficients, and can include the set of all such possible linear combination coefficients for the display device.

The processor 121 can transform the output color palette to a spectral space color palette. For example, the transformation can be performed by an output color palette transformation module 123. The dimensionality of the spectral space can be, in some implementations, greater than the number of primary colors, and in some cases, much greater than the number of primary colors (e.g., two, three, or four times the number of primary colors). In various implementations, the spectral space can have a dimensionality based at least in part on a wavelength range associated with the primary colors. In certain implementations, the spectral space can also have a dimensionality based at least in part on a sampling interval of the wavelength range associated with the primary colors. The dimensionality can be the wavelength range divided by the sampling interval. The number of sample wavelengths used to represent the wavelength range can be regarded as the dimensionality of the spectrum, and thus of the spectral space. Any sampling intervals can be used, e.g., 1 nm, 2 nm, 3 nm, 4 nm, 5 nm, 10 nm, 15 nm, and so forth. As an example, if the wavelength range associated with the primary colors extends from 400 nm to 700 nm and is sampled at 1 nm intervals, then each of the N primary colors of the display device can have a spectrum represented by 301 values. In other words, the dimensionality D of the spectral space can be 301 in this example. This spectral space, in some implementations, can be the most general space for color processing where little or substantially no metamerism may be possible. In some implementations, if the spectra of two colors are different, they may not be metameric. In certain implementations, the output color palette transformation module 123 can create a matrix A having matrix dimensions of D×N (e.g., 301×N in the above example where D represents the dimensionality of the spectral space and N represents the number of primary colors), where each column of the matrix A can describe the spectrum of each primary color.

In one approach to transform a color palette to a desired color space, the color coordinates of the primary colors in the desired space can be multiplied by the color palette matrix B For example, to transform a color palette to an sRGB color space, the color coordinates of the primary colors in sRGB color space are multiplied by the color palette matrix B to form the sRGB coordinates of the palette colors. However, such a transformation (e.g., into three-dimensional space), can lead to metamerism if all the primary combinations are used in certain implementations. Thus, in certain other implementations, the output color palette can be transformed to a spectral space color palette by multiplying the spectra of the primary colors by the matrix B. For example, multiplying the matrix A of matrix dimensions D×N (e.g., the spectral domain representation of the primary colors) by the matrix B of dimensions N×m (e.g., the linear combination of coefficients for the primary colors) can transform the output color palette to the spectral space color palette (e.g., the spectrum of all possible colors that can be formed by a combination of the N primary colors and the given t time slots in certain implementations).

In some implementations, since the computational cost of color processing in the full spectral domain can be high due to the high number of dimensions in the spectral space (e.g., 301 in the above example), it can be desirable to reduce the dimensionality of the spectral space by transforming the spectral data to a lower dimensional space while still substantially avoiding metamerism. For example, if the input spectra has a full dimensionality of 301 for each primary color (e.g., sampling the visible spectrum 400 nm to 700 nm at 1 nm intervals), a reduced dimensionality can be achieved by sampling at 10 nm intervals, yielding a color palette in 31 dimensions for each primary color. Accordingly, the dimensionality D of the spectral space can depend, at least in part, on the wavelength range (e.g., the visible portion of the electromagnetic spectrum) and/or the sampling interval of the wavelength range (e.g., 1 nm or 10 nm in the above examples). By increasing the sampling interval, the dimensionality of the spectral space can be reduced (e.g., from 310 to 31 dimensions) to achieve a reduced-dimensionality spectral space that can lead to increased processing efficiency as compared to a higher dimensionality spectral space. Further examples of a reduced-dimensionality spectral space are described below.

The processor 121 can be configured to receive data on an input color to be output by the display device 100. For example, the processor 121 can be configured to receive image data to be displayed as an image by the display elements 130. For example, the processor 121 can receive image data, such as compressed image data from a network interface or an image source module 127. The processor 121 can process the image data into raw image data or into a format that is readily processed into raw image data. The image data can include information that identifies the image characteristics, e.g., color, hue, saturation, brightness, and gray-scale level, at each location within an image. For example, the image data can include the input color data 128 that can be produced by the output device 100. The input color data 128 can include the three-dimensional color chromaticity coordinates, e.g., xyY, L*u′v′, L*a*b*, XYZ, RGB, sRGB, LMS, or other color space model.

The processor 121, e.g., by the input color separation module 124, can separate the input color into a combination of the primary colors that can create the input color. For example, for a given input color in the input image (e.g., after gamut mapping), a set of coefficients, α, of linear combination of primaries that form the input color can be obtained. In some implementations, this can refer to forming a one-to-one mapping from the trichromatic color space (e.g., sRGB) to the primary colors. As an example, in certain implementations, the input color can be separated to a theoretical combination of primary colors. In various implementations, the input color can be separated to a theoretical combination of primary colors and respective time slots. In some implementations, the processor 121 can be configured to separate the input color by using a separate volume or a subvolume method to determine the primary colors for creating the input color.

The processor 121 can then transform the input color to the spectral space. For example, the transformation can be performed by an input color transformation module 125. The transformation of the input color to the spectral space can be performed after, before, or simultaneously as the transformation of the output color palette to the spectral space. In certain implementations, the input color can be transformed to the spectral space by multiplying the vector of coefficients, a by the primary spectra. For example, each primary color, e.g., each red, green, cyan, or orange pixel, can have certain known reflectance characteristics. By combining the primary colors together to create a color, a spectrum can be associated with the created color using the spectral characteristics of the primary colors. As one example, with five primary colors (N=5), for a given input color, e.g., (0.3, 0.7, 0.1) in sRGB, the input color separation module 124 can yield the a coefficients, e.g., [0.1, 0.12, 0.4, 0.6, 0.3]. The representation of this color in the spectral domain can be given by α×A, where as discussed earlier, A can be the matrix of primary spectra in the spectral domain. Thus, in various implementations, the processor 121 can be configured to transform the input color to the spectral space based at least in part on the separated input color and the spectra of the primary colors.

The processor 121, e.g., by the selection module 126, can select or quantize a color in the spectral space color palette based at least in part on the input color in the spectral space. In certain implementations, the processor 121 can be configured to select the color as the color in the spectral space color palette that is closest to the input color. By working in the spectral space, the processor 121 can find the closest spectrum in the output color palette to the spectrum of the input image color. In effect, by working in the spectral space, the closest spectrum, which renders a color combination that can reduce metamerism, is found rather than simply the closest overall color. In certain implementations, closeness can be defined using an appropriate metric, such as an L₂-norm in the spectral space.

Although FIG. 6 illustrates the modules 122-126 within the processor 121 as separate modules, the modules within the processor 121 can be combined with other modules. For example, in some implementations, the input color transformation module 125 can be separate from the input color separation module 124, while in other implementations, the input color separation module 124 and the input color transformation module 125 can be the same module. In some implementations, the output color palette transformation module 123 can be separate from the output color palette creation module 122, while in other implementations, the output color palette creation module 122 and the output color palette transformation module 123 can be the same module. In addition, in some implementations, the input color transformation module 125 can be separate from the output color palette transformation module 123, while in other implementations, the input color transformation module 125 and the output color palette transformation module 123 can be the same module. The modules 122-126 can be configured differently than shown in FIG. 6, for example, functionality implemented by the modules can be combined, separated, merged, or removed in various implementations.

In certain implementations, the selected color can be stored in a computer-readable medium while the processor 121 repeats the operations to select another color for another input color until all of the input colors of one or more input images are selected. In certain implementations, the transformation of the output color palette to the spectral space can be stored in a computer-readable medium, e.g., as those described herein, until multiple colors are selected for multiple input colors, e.g., for all of the input colors of one or more input images. Theoretically, the output color palette can be created and transformed to the spectral space once for the lifetime of the display device 100. However, in various implementations, the output color palette can be created and transformed to the spectral space each time the processor 121 begins operating to account for any changes in the display elements 130.

As discussed above, in certain implementations, to speed up the computation of finding the closest spectrum, the processor 121 can be configured to select the color in a reduced-dimensionality spectral space having fewer dimensions than the dimensionality of the spectral space. For example, the dimensionality of the spectral data can be reduced to find a lower dimensional spectral space that captures substantially all of the variance of the data while still substantially avoiding metamerism. In some implementations, the reduced-dimensionality spectral space can also be determined using Principle Component Analysis (PCA). For example, in one example, the higher dimensional spectral space may have 31-dimensions but through PCA, a lower dimensional (e.g., 9-dimensional or 5-dimensional) spectral space may capture a high percentage (e.g., greater than about 80%, greater than about 90%, greater than about 95%, or almost about 100%) of the data variance and can allow the computations to be performed much more rapidly than in the original (e.g., 31-dimensional) spectral space.

In certain implementations, the processor 121 further can be configured to communicate the selected color to at least one of the display elements 130 to produce the input color on the display device 100. When rendering an image, the quantization error between the selected color and the input color can be diffused to neighboring display elements 130, e.g., pixels. For example, the quantization error can be diffused to the neighboring display elements 130 by using a dithering algorithm, e.g., the Floyd-Steinberg dithering algorithm. In certain implementations, the quantization error can be diffused using schemes in a trichromatic color space, e.g., sRGB. However, in other implementations, the quantization error can be diffused using schemes in spectral space. For example, the processor 121 can be configured to, for a first group of display elements 130, determine, in the spectral space, a quantization error between the selected color and the input color. The processor 121 can then diffuse, in the spectral space, the quantization error to a second group of display elements 130 neighboring the first group of display elements 130.

Due to the sparsity of the color palette using trichromatic color processing, colors that are close to each other in a trichromatic color space, e.g., shades of skin tone, are typically quantized to palette points that can be made up of different sets of primary colors, which can have very different spectra. As a result, nearby colors in the produced image may shift in different amounts under change of viewing angle. For example, dither spots, e.g., alternating pink and green spots in a skin tone image, can be observed. By performing quantization in spectral space, since there are many more palette points compared to a trichromatic color space, image colors that are close to the input color can be quantized to palette colors that are also close-by in spectral distribution. As a result, under a change of viewing angle, different pixels that belong to the same shade in the image (e.g., skin) might not shift in vastly different ways. Thus, certain implementations of display devices 100 can lead to less dither visibility in the images rendered on a multi-primary display while substantially avoiding metamerism.

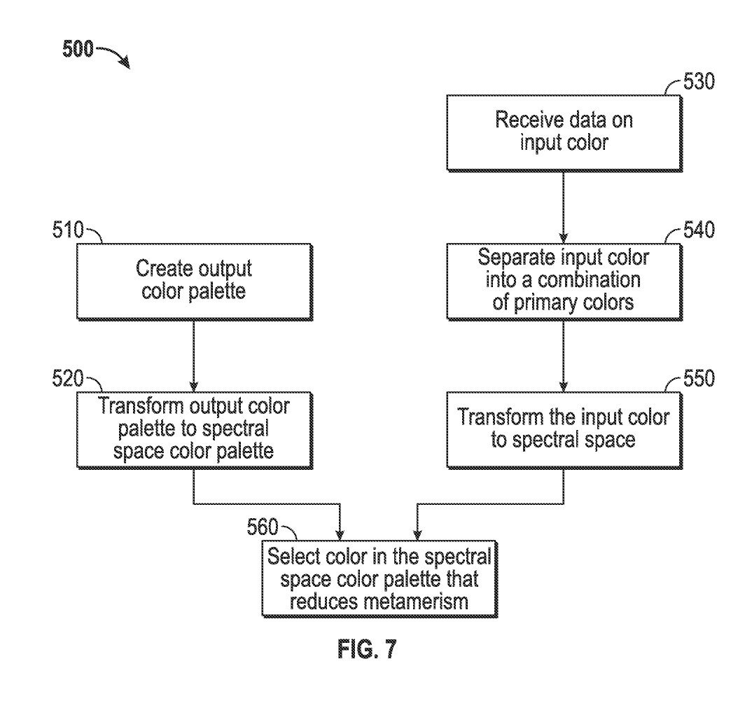

FIG. 7 illustrates an example method of processing color on a display device 100 that selects a color that reduces metamerism. The display device 100 can be a multi-primary display device as described herein. For example, the multi-primary display device 100 can be configured to output a number of primary colors that is greater than or equal to four. The display device 100 can include display elements 130. Each of the display elements 130 can be configured to output at least one of the primary colors.

The method 500 can include creating an output color palette of colors capable of being output by the display elements 130 of the display device 100, as shown in block 510. As shown in block 520, the method 500 can include transforming the output color palette to a spectral space color palette. The spectral space can have a dimensionality based at least in part on a wavelength range associated with the primary colors and/or a sampling interval of the wavelength range.

As shown in block 530, the method 500 can include receiving data on an input color to be output by the display device 100. After receiving data on an input color to be output by the display device 100, the method 500, as shown in block 540, can include separating the input color into a combination of the primary colors that can create the input color. As shown in block 550, the method 500 can include transforming the input color to the spectral space. For example, transforming the input color to the spectral space can be based at least in part on the separated input color and spectra of the primary colors.

Furthermore, the method 500 can include selecting a color in the spectral space color palette based at least in part on the input color in the spectral space, as shown in block 560. The selected color can reduce metamerism. In some implementations, selecting the color can include selecting the color in the spectral space color palette that is closest to the input color, e.g., using an L₂-norm in the spectral space.

In certain implementations, the method 500 can be performed in its entirety by a physical computing device. In some implementations, the method 500 further can include communicating the selected color to at least one of the display elements 130 to produce the input color on the display device 100.

FIGS. 8A and 8B are system block diagrams illustrating a display device 40 that includes a plurality of IMOD display elements. In certain implementations, the display device 40 can include the example display device 100 as described herein. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable, multi-state, or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein. In certain implementations, the display 30 can provide reduced metamerism and reduced color shifts with changes in viewing angle when compared to other displays.

The components of the display device 40 are schematically illustrated in FIG. 8A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. In certain implementations, the processor 21 can include the processor 121 or can function as the processor 121 described herein. Methods described herein, e.g., method 500, can be implemented via execution of instructions by the processor 21. The driver controller 29 can be coupled to a frame buffer 28, and to an array driver 22, which in turn can be coupled to a display array 30. One or more elements in the display device 40, including elements not specifically depicted in FIG. 8A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, e.g., an image source module 127 as shown in FIG. 6, and processes the data into raw image data or into a format that can be readily processed into raw image data. The processor 21 can be programmed to implement the method 500 shown in FIG. 7. The processor 21 can send the processed data to the driver controller 29 or to the frame buffer 28 for storage. Raw data typically refers to the information that identifies the image characteristics at each location within an image. For example, such image characteristics can include color, hue, saturation, brightness, and gray-scale level. The image data can include data on the input color to be produced by the display device 40.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein, e.g., method 500 shown in FIG. 7, may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A multi-primary display device configured to output a number of primary colors that is greater than or equal to four, the display device comprising:
a plurality of display elements, each display element configured to output at least one of the primary colors; and
a processor in communication with the display elements, the processor configured to:
create an output color palette of colors capable of being output by the display elements of the multi-primary display device;
transform the output color palette to a spectral space color palette, wherein the spectral space has a dimensionality based at least in part on a wavelength range associated with the primary colors;
receive data on an input color to be output by the multi-primary display device;
separate the input color into a combination of the primary colors that can create the input color;
transform the input color to the spectral space; and
select a color in the spectral space color palette based at least in part on the input color in the spectral space, wherein the selected color reduces metamerism.

2. The display device of claim 1, wherein the spectral space has a dimensionality based at least in part on a sampling interval of the wavelength range.

3. The display device of claim 1, wherein the plurality of display elements is temporally modulated such that the plurality of display elements is capable of outputting one or more of the primary colors for respective amounts of time in a number of time slots.

4. The display device of claim 1, wherein the processor is configured to separate the input color by using a subvolume method to determine the primary colors for creating the input color.

5. The display device of claim 1, wherein the processor is configured to transform the input color to the spectral space based at least in part on the separated input color and spectra of the primary colors.

6. The display device of claim 1, wherein the processor is configured to select the color as the color in the spectral space color palette that is closest to the input color.

7. The display device of claim 6, wherein the processor is configured to select the closest color using an L₂-norm in the spectral space.

8. The display device of claim 1, wherein the processor is configured to select the color in a reduced-dimensionality spectral space having fewer dimensions than the dimensionality of the spectral space.

9. The display device of claim 8, wherein the reduced-dimensionality spectral space is determined using principle component analysis.

10. The display device of claim 1, wherein the processor is further configured to:
for a first plurality of display elements, determine, in the spectral space, a quantization error between the selected color and the input color; and
diffuse, in the spectral space, the quantization error to a second plurality of display elements neighboring the first plurality of display elements.

11. The display device of claim 10, wherein the processor is configured to diffuse the quantization error to the neighboring plurality of display elements using a dithering algorithm.

12. The display device of claim 1, wherein the processor is further configured to communicate the selected color to at least one display element to produce the input color on the multi-primary display device.

13. The display device of claim 1, further comprising:
a display, wherein the processor is configured to process image data and communicate with the display; and
a memory device configured to communicate with the processor,
wherein the image data includes the data on the input color.

14. The display device of claim 13, further comprising:
a driver circuit configured to send at least one signal to the display; and
a controller configured to send at least a portion of the image data to the driver circuit.

15. The display device of claim 13, further comprising:
an image source module configured to send the image data to the processor,
wherein the image source module includes at least one of a receiver, transceiver, and transmitter.

16. The display device of claim 13, further comprising:
an input device configured to receive input data and to communicate the input data to the processor.

17. The display device of claim 1, wherein each display element includes an interferometric modulator.

18. A multi-primary display device configured to output a number of primary colors that is greater than or equal to four, the display device comprising:
means for displaying at least one of the primary colors; and
means for processing in communication with the displaying means, the processing means configured to:
create an output color palette of colors capable of being output by the displaying means of the multi-primary display device;
transform the output color palette to a spectral space color palette, wherein the spectral space has a dimensionality based at least in part on a wavelength range associated with the primary colors;
receive data on an input color to be output by the multi-primary display device;
separate the input color into a combination of the primary colors that can create the input color;
transform the input color to the spectral space; and
select a color in the spectral space color palette based at least in part on the input color in the spectral space, wherein the selected color reduces metamerism.

19. The display device of claim 18, wherein the spectral space has a dimensionality based at least in part on a sampling interval of the wavelength range.

20. The display device of claim 18, wherein the displaying means includes a plurality of display elements, or the processing means includes a processor.

21. The display device of claim 20, wherein each display element includes an interferometric modulator.

22. The display device of claim 18, wherein the displaying means is temporally modulated such that the displaying means is capable of outputting one or more of the primary colors for respective amounts of time in a number of time slots.

23. The display device of claim 18, wherein the processing means is configured to transform the input color to the spectral space based at least in part on the separated input color and spectra of the primary colors.

24. The display device of claim 18, wherein the processing means is configured to select the color as the color in the spectral space color palette that is closest to the input color.

25. The display device of claim 24, wherein the processing means is configured to select the closest color using an L₂-norm in the spectral space.

26. The display device of claim 18, wherein the processing means is further configured to communicate the selected color to the displaying means to produce the input color on the multi-primary display device.

27. A method of processing color on a multi-primary display device, the multi-primary display device configured to output a number of primary colors that is greater than or equal to four, the multi-primary display device including a plurality of display elements, each display element configured to output at least one of the primary colors, the method comprising:
creating an output color palette of colors capable of being output by the display elements of the multi-primary display device;
transforming the output color palette to a spectral space color palette, wherein the spectral space has a dimensionality based at least in part on a wavelength range associated with the primary colors;
receiving data on an input color to be output by the multi-primary display device;
separating the input color into a combination of the primary colors that can create the input color;
transforming the input color to the spectral space; and
selecting a color in the spectral space color palette based at least in part on the input color in the spectral space, wherein the selected color reduces metamerism,
wherein the method is performed in its entirety by a physical computing device.

28. The method of claim 27, wherein the spectral space has a dimensionality based at least in part on a sampling interval of the wavelength range.

29. The method of claim 27, wherein transforming the input color to the spectral space is based at least in part on the separated input color and spectra of the primary colors.

30. The method of claim 27, wherein selecting the color includes selecting the color in the spectral space color palette that is closest to the input color.

31. The method of claim 30, wherein selecting the closest color includes using an L₂-norm in the spectral space.

32. The method of claim 27, further comprising communicating the selected color to at least one display element to produce the input color on the multi-primary display device.

33. A non-transitory tangible computer storage medium having stored thereon instructions to process color on a multi-primary display device, the multi-primary display device configured to output a number of primary colors that is greater than or equal to four, the multi-primary display device including a plurality of display elements, each display element configured to output at least one of the primary colors, wherein the instructions when executed by a computing system cause the computing system to perform operations comprising:
creating an output color palette of colors capable of being output by the display elements of the multi-primary display device;
transforming the output color palette to a spectral space color palette, wherein the spectral space has a dimensionality based at least in part on a wavelength range associated with the primary colors;
receiving from a computer-readable medium data on an input color to be output by the multi-primary display device;
separating the input color into a combination of the primary colors that can create the input color;
transforming the input color to the spectral space; and
selecting a color in the spectral space color palette based at least in part on the input color in the spectral space, wherein the selected color reduces metamerism.

34. The computer storage medium of claim 33, wherein the spectral space has a dimensionality based at least in part on a sampling interval of the wavelength range.

35. The computer storage medium of claim 33, wherein transforming the input color to the spectral space is based at least in part on the separated input color and spectra of the primary colors.

36. The computer storage medium of claim 33, wherein selecting the color includes selecting the color as the color in the spectral space color palette that is closest to the input color.

37. The computer storage medium of claim 36, wherein selecting the closest color includes using an L₂-norm in the spectral space.

38. The computer storage medium of claim 33, wherein the operations further comprise communicating the selected color to at least one display element to produce the input color.
